(19) United States
(12) Patent Application Publication
(10) Pub. No.: US 2007/0019313 A1
(43) Pub. Date: Jan. 25, 2007

(54) Method for production of a tunable optical filter

(75) Inventors: Alain Mugnier, Begard (FR); Rachelle Le Roux, Pleumeur-Gautier (FR); Philippe Yvemault, Lannion (FR); David Pureur, Perros-Guirec (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Highwave Optical Technologies, Lannion (FR)

(21) Appl. No.: 10/511,565

(22) PCT Filed: Apr. 15, 2003
(86) PCT No.: PCT/FR03/01197

§ 371 Date: Aug. 3, 2006

(30) Foreign Application Priority Data
Apr. 17, 2002 (FR) 02/04821

(51) Int. Cl. G02B 5/08

(52) U.S. Cl. 359/884

(57) ABSTRACT

The present invention relates to a method of producing an optical filter, characterized in that it comprises effecting the following steps on an optical waveguide (10): controlling the varying interior profile of the waveguide, preferably by melt-drawing, and writing a Bragg grating (20), using techniques allowing independent control of longitudinal variation of the Bragg wavelength and longitudinal variation of the exterior profile of the waveguide.

### TECHNICAL FIELD

The present invention relates to the field of telecommunications and more particularly to that of optical communications via optical fiber.

To be even more precise, the present invention relates to the field of optical waveguide filters, preferably tunable optical waveguide filters. Thus it is aimed in particular at the production of fixed or tunable chromatic dispersion compensators.

1. Technical Problem Addressed

The general technical problem that the present invention aims to solve is that of producing tunable optical filters.

One particularly significant example of this technical problem is the need for tunable chromatic dispersion compensation for the deployment of optical networks operating at high bit rates (40 gigabits per second (Gbit/s) and above).

The expression “chromatic dispersion” refers to the temporal widening of light pulses as they propagate in an optical fiber, which results primarily from variations of the refractive index as a function of the wavelength. This temporal widening leads to temporal overlapping of successive pulses after propagating over long distances, which causes bit errors at the receiver.

At present, given the increase in the density of communications, the deployment of high bit rate networks is being greatly impeded by chromatic dispersion.

In high bit rate systems the dispersion tolerances become small, with the result that dispersion variations that until now have been negligible in a 10 Gbit/s system may strongly influence the performance of 40 Gbit/s communication networks. The tolerances are inversely proportional to the square of the bit rate. They are typically 500 picoseconds per nanometer (ps/nm), 30 ps/nm and 2 ps/nm for bit rates of 10 Gbit/s, 40 Gbit/s and 160 Gbit/s, respectively.

What is more, the amount of dispersion compensation needed at the receiver to maintain optimum performance of the system may vary in time as a result of problems such as temperature fluctuations along the fiber and dynamic reconfiguration of the network.

Active control of dispersion compensation to overcome the above problems is therefore of primary importance in high bit rate systems. In particular, it is necessary to compensate residual chromatic dispersion channel by channel using a tunable device at the line end.

2. Prior Art

A certain number of solutions to the problem of tunable chromatic dispersion compensation have been proposed in the past.

A first solution uses a resonant cavity forming a Gires-Tournois etalon and provides tunability by modifying either the angle of incidence or the temperature of the component (see Patent EP 1 098 212 “Tunable dispersion compensator”). That solution has the drawback that it is not an all-fiber solution and a priori has substantial insertion losses. The delay of a single etalon is not linear, and only a combination of two elements can achieve constant dispersion in the wanted band. Moreover, since the maximum dispersion is inversely proportional to the square of the bandwidth, the tuning range is insufficient for the bandwidths currently of interest for optical telecommunications.

Another and more widely used solution uses a fiber Bragg grating in which the period of the grating varies along the grating. Varying the Bragg wavelength longitudinally, which is usually referred to as “chirping” the Bragg grating, induces a reflection delay that varies as a function of the incident wavelength. To write a Bragg grating within the fiber, the core is doped with a material rendering the fiber photosensitive, and possibly a portion of the optical cladding likewise. Longitudinal modulation of the refractive index is then induced by irradiating the fiber with a field of ultraviolet fringes created by an interferometer (preferably using a phase mask with the required longitudinal period variation).

Various options have been envisaged for making this type of component tunable. Two physical parameters can locally modify the Bragg wavelength, namely mechanical stress and temperature.

A first option for modifying the dispersion is to induce a longitudinal variation in one of these two parameters. Many examples illustrate this option (see for example patent EP 1 024 376 “Optical grating device with variable coating” or patent EP 1 030 472 “Optical communication system incorporating automatic dispersion compensation modules”). The means proposed for that purpose generally use deposits with a thickness varying along the fiber, the deposits being either of a conductive metal, to act on the temperature, or of a material with mechanical properties similar to those of silica, to act on mechanical stress. However, it is not necessarily a simple matter to control that kind of thickness gradient, and a high maximum thickness is needed to achieve a sufficient stress gradient. Moreover, that method of dispersion tuning is accompanied by a shift in the central wavelength of the filter.

A second dispersion tuning option uses chirping that is varied longitudinally in a non-linear manner; thus it is possible to design a Bragg grating whose dispersion in the reflective band varies in a virtually linear manner, for example. This approach has been proposed using a non-linear variation of the Bragg grating period (see patent WO 99/31537 “Tunable nonlinearly chirped grating”). Dispersion tuning is then achieved by spectrally offsetting the reflective band relative to the signal using a standard method of varying the central wavelength of a Bragg grating (by applying either a uniform temperature rise or traction). Since in that situation the dispersion is not constant over the bandwidth of the signal, the major drawback of that kind of dispersion compensation method is the introduction of higher order dispersion, which induces a significant increase in the power penalty induced by the component.

### GENERAL DESCRIPTION OF THE INVENTION

A general object of the invention is to provide dispersion correction that is tunable over a band of wavelengths.

This object is achieved in the context of the present invention by a method of producing an optical filter that comprises effecting the following steps on an optical waveguide:
controlling the varying interior profile of the waveguide (i.e. the exterior profile of the guiding part proper, for example the core in the case of an optical fiber), and
writing a Bragg grating,
   using techniques allowing independent control of longitudinal variation of the Bragg wavelength and longitudinal variation of the exterior profile of the waveguide.

In one advantageous implementation of the invention, the step of controlling the varying interior profile of the waveguide is effected by melt-drawing.

The invention therefore provides a tunable filter in an optical waveguide whose spectral response may be controlled by applying an external mechanical force, for example a traction force, but equally a torsion force or a compression force, or by any other equivalent means.

The filter is preferably reflective.

The Bragg grating is advantageously written after the step of controlling the varying interior profile of the optical waveguide.

Two main variants of the method of the present invention are proposed.

In a first variant, the step of controlling the varying interior profile of the optical waveguide is effected under conditions allowing control of the longitudinal variation of the effective optical index of the waveguide, the step of controlling the varying interior profile of the waveguide is followed by a step of locally correcting the exterior profile of the waveguide, and the step of writing the Bragg grating is effected under conditions that enable longitudinal control of the Bragg wavelength.

The profile correction step may be carried out before or after the step of writing the Bragg grating.

In a second variant, the step of controlling the varying interior profile of the optical waveguide is effected under conditions enabling control of the longitudinal variation of the exterior profile of the waveguide and the longitudinal variation of the step of the grating is controlled during writing of the Bragg grating to enable control of the longitudinal variation of the Bragg wavelength.

According to another advantageous feature of the present invention, the method adds to the optical waveguide comprising a written filter a device for controlling and/or monitoring an applied mechanical force, for example a traction force.

Firstly, by combining control of the longitudinal variation of the effective index by controlling the varying interior profile of the waveguide and control of the longitudinal variation of the grating period by using an appropriate writing process, the longitudinal variation of the Bragg wavelength of the grating, and thus the associated spectral response, is controlled under the traction conditions that apply when writing the grating.

Secondly, combining control of the exterior profile of the waveguide by controlling the varying interior profile of the waveguide, and where applicable modifying that profile after controlling the varying interior profile of the waveguide, means that the spectral response varies independently when the applied traction is modified.

According to another advantageous feature of the present invention, the method further comprises the step of adding to the optical waveguide means for inducing a longitudinal wavelength variation that is preferably uniform.

For example, such means may be adapted to control the temperature of the component.

For example, this may be achieved by metallizing its surface or by inserting it into a microfurnace, for example into a capillary, the metallization or the microfurnace being heated by the Joule effect or by thermal conduction.

The means for inducing a uniform and controlled variation of the wavelength in particular combat the effect of the offsetting of the central wavelength of the filter resulting from the application of a mechanical force, for example a traction force.

The present invention also consists in optical waveguides comprising a filter written by the above method and the use of such guides.

Other features, objects and advantages of the present invention will become apparent on reading the following detailed description, which is given with reference to the appended drawings, which are provided by way of non-limiting example and in which:

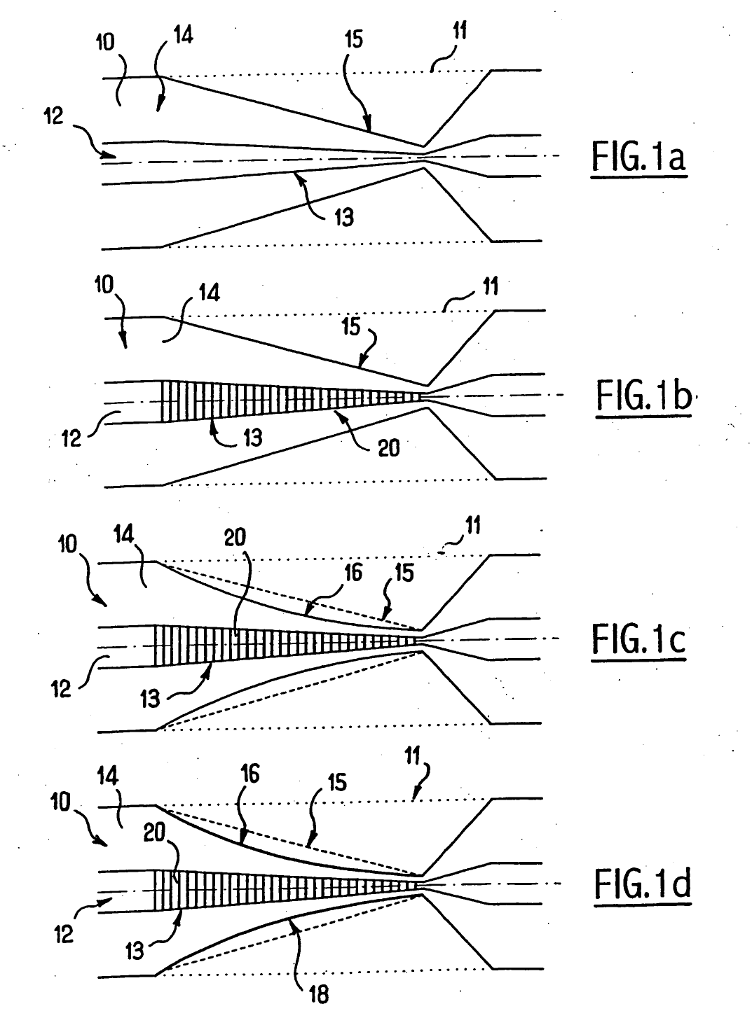

FIG. 1 shows successive steps of a first implementation of a method in accordance with the present invention for producing a waveguide comprising a written filter, and to be more precise FIG. 1a shows a step of controlling the varying interior profile of the waveguide by melt-drawing, FIG. 1b shows a step of writing a Bragg grating, FIG. 1c shows a step of correcting the exterior profile by gradual attack, and FIG. 1d shows a metallization step;

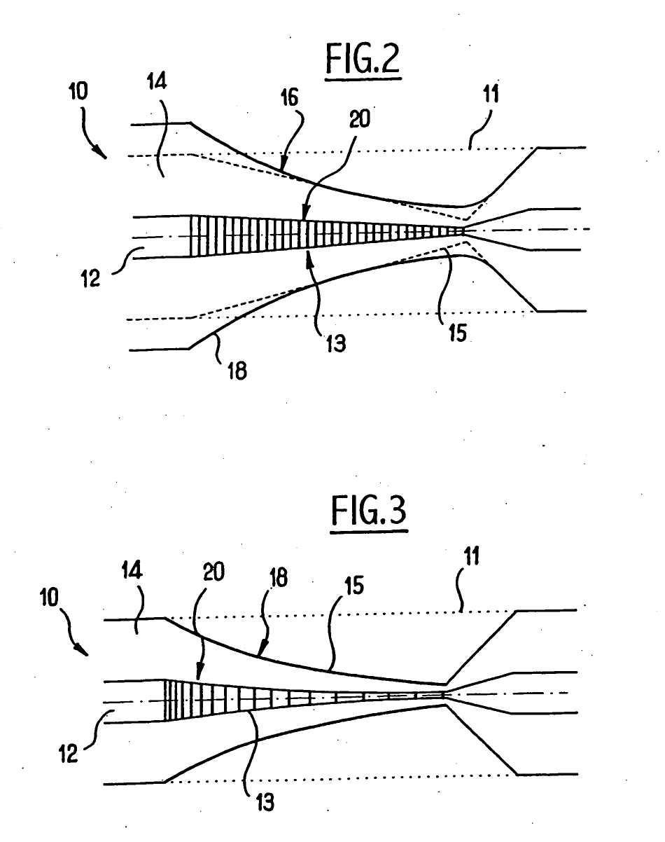

FIG. 2 shows diagrammatically a step of modifying the exterior profile by depositing a material having mechanical properties analogous to those of the material constituting the guide, as an alternative to the step shown in FIG. 1c;

FIG. 3 shows diagrammatically an optical waveguide produced by a second implementation of the method of the present invention which produces the required exterior profile during the step of controlling the varying interior profile of the waveguide by melt-drawing and controlling the longitudinal variation of the Bragg wavelength by means of longitudinal variation of the period of the grating;

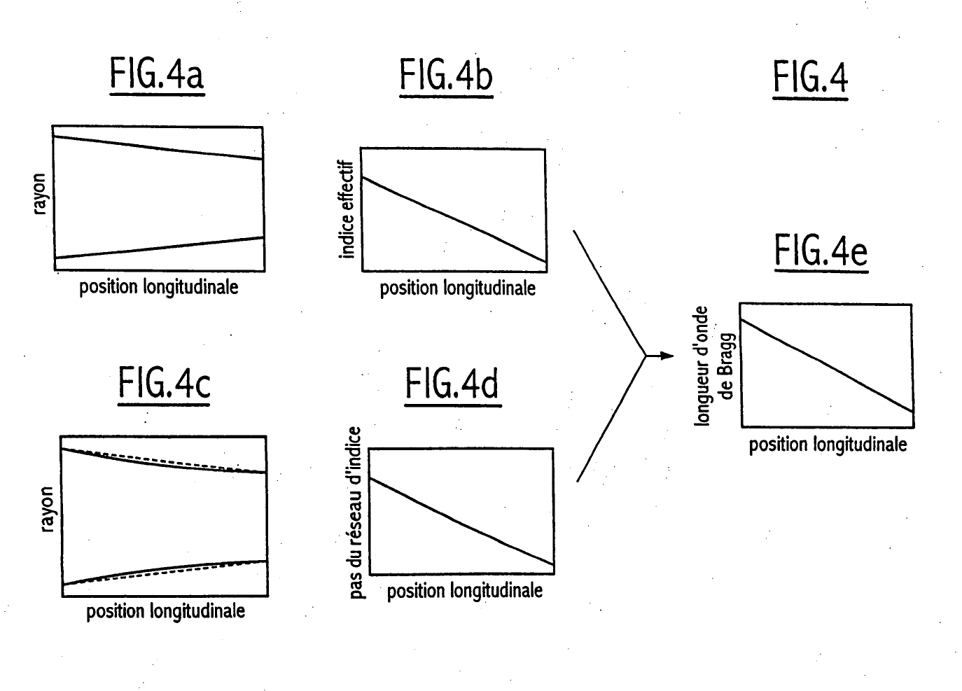

FIG. 4 shows diagrammatically the production of a chromatic dispersion compensator by a first implementation of the method, and to be more precise FIG. 4a shows the radius of the waveguide as a function of longitudinal position and FIG. 4b shows the effective index of the waveguide as a function of longitudinal position after carrying out a production step of controlling the varying interior profile of the guide by melt-drawing of the exterior profile, producing a linear variation of the effective index, FIG. 4c shows the radius as a function of longitudinal position after carrying out a step of correcting the exterior profile to obtain the profile required for tunability, FIG. 4d shows the period of the index grating as a function of longitudinal position after the step of writing a Bragg grating whose period varies linearly, and FIG. 4e shows the Bragg wavelength resulting from the above steps as a function of longitudinal position, and indicates linear variation of the Bragg wavelength;

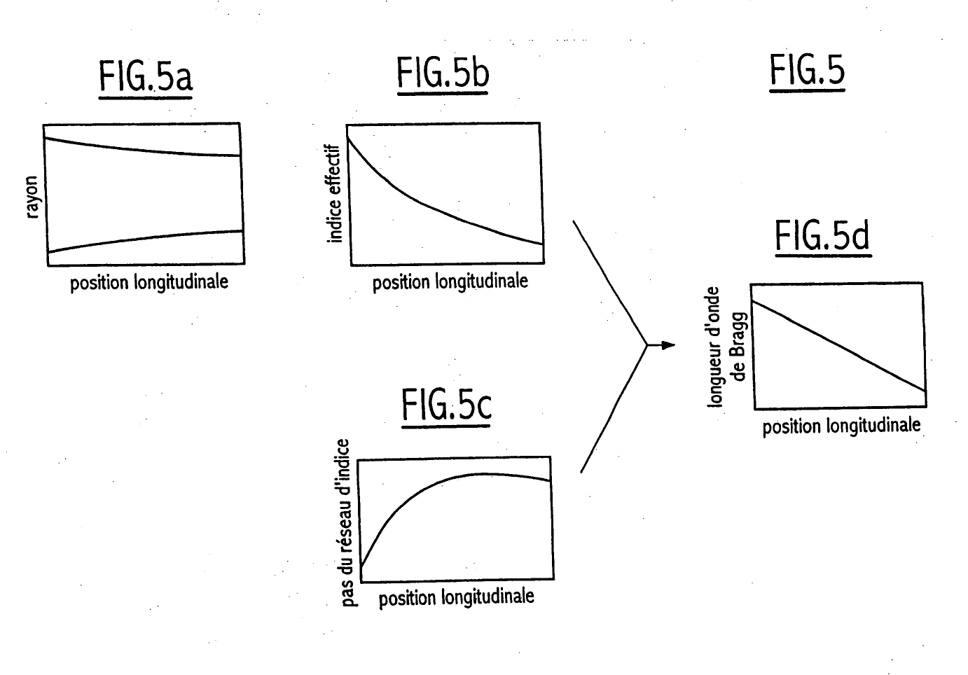

FIG. 5 shows diagrammatically the production of a chromatic dispersion compensator by a second implementation of the method of the present invention, and to be more precise FIG. 5a shows the radius of the waveguide as a function of longitudinal position after the production step of controlling the varying interior profile of the waveguide by melt-drawing of the exterior profile as required for tunability, FIG. 5b shows the effective optical index of the waveguide as a function of longitudinal position after the above step of controlling the varying interior profile of the waveguide by melt-drawing, the effective index varying as a function of longitudinal position in a non-linear manner, FIG. 5c shows the period of the index grating as a function of longitudinal position after the step of writing a Bragg grating whose period varies in an appropriate non-linear manner, and FIG. 5d shows the Bragg wavelength as a function of longitudinal position and again indicates linear variation of the Bragg wavelength as a function of longitudinal position;

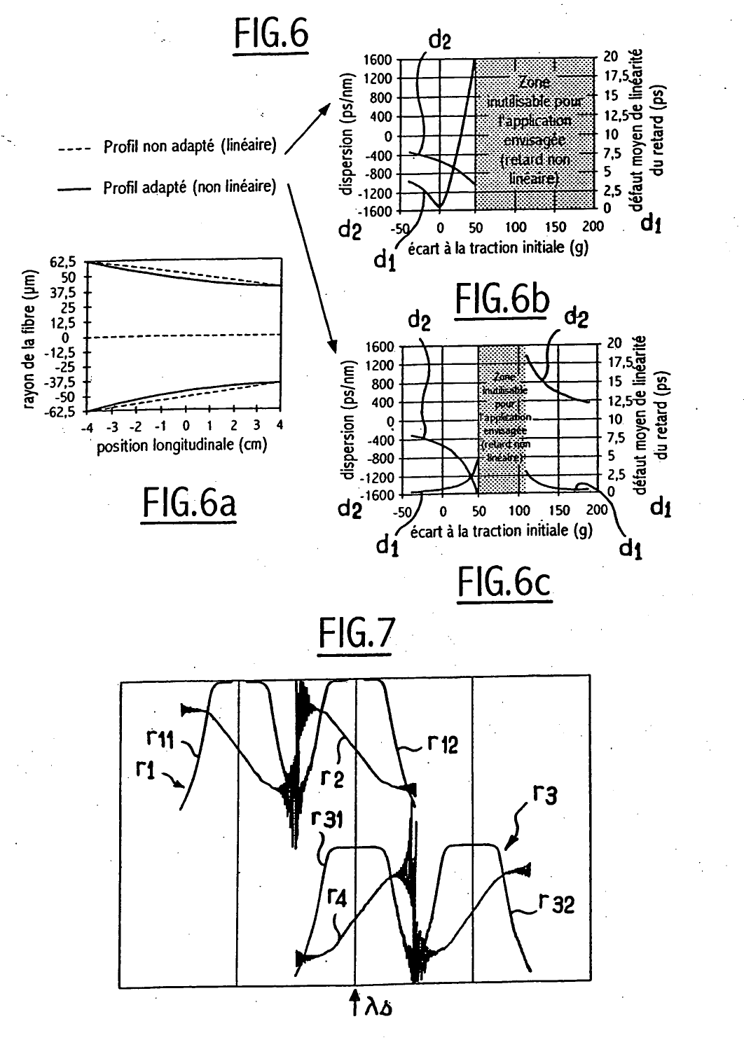

FIG. 6 demonstrates the benefit of controlling the exterior profile in the case of a dispersion compensator, and to be more precise FIG. 6a shows in dashed line the radius of the fiber as a function of longitudinal position in the case of an unmodified linear profile and in continuous line the radius of the fiber as a function of longitudinal position in the case of a modified non-linear profile, FIG. 6b shows the dispersion and the mean linearity error of the delay as a function of the difference with respect to the original traction force in the case of a linear unmodified profile, and FIG. 6c shows the dispersion and the mean linearity error of the delay as a function of the difference with respect to the original traction force in the case of a modified non-linear profile conforming to the present invention;

FIG. 7 shows one example of the application of controlling the longitudinal variation of the index modulation in the case of a dispersion compensator and its upper portion shows the spectral characteristics (reflectivity and delay) respectively with the original traction and after application of additional traction to invert the sign of the dispersion;

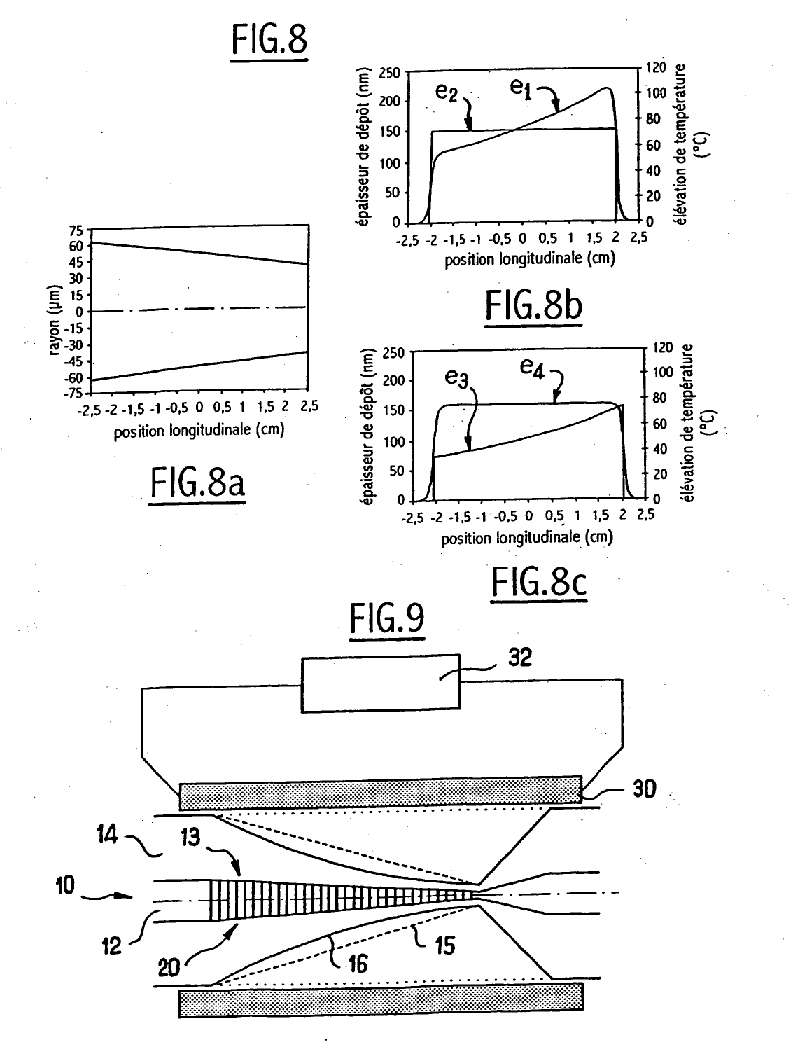

FIG. 8 shows one method of heating by means of an applied metallization, and to be more precise FIG. 8a shows the radius of a waveguide as a function of longitudinal position, FIG. 8b shows a metallization deposit thickness and the resulting temperature rise as a function of longitudinal position in the case of an uniform deposit thickness, and FIG. 8c shows in a similar manner a metallization deposit thickness and the resulting temperature rise as a function of longitudinal position in the case of a modified deposit thickness;

FIG. 9 shows one method of heating the waveguide conforming to the present invention by inserting the component into a capillary;

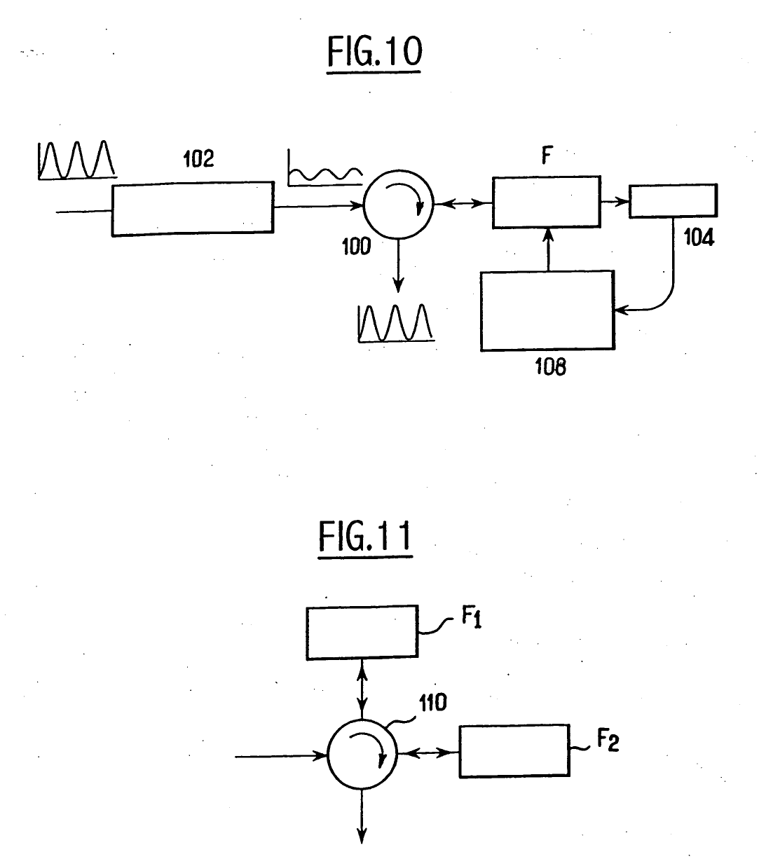

FIG. 10 shows diagrammatically one example of a system configuration incorporating a dispersion compensator conforming to the present invention and comprising a three-port circulator and a feedback loop;

FIG. 11 shows another example of a system configuration incorporating the invention and combining two filters;

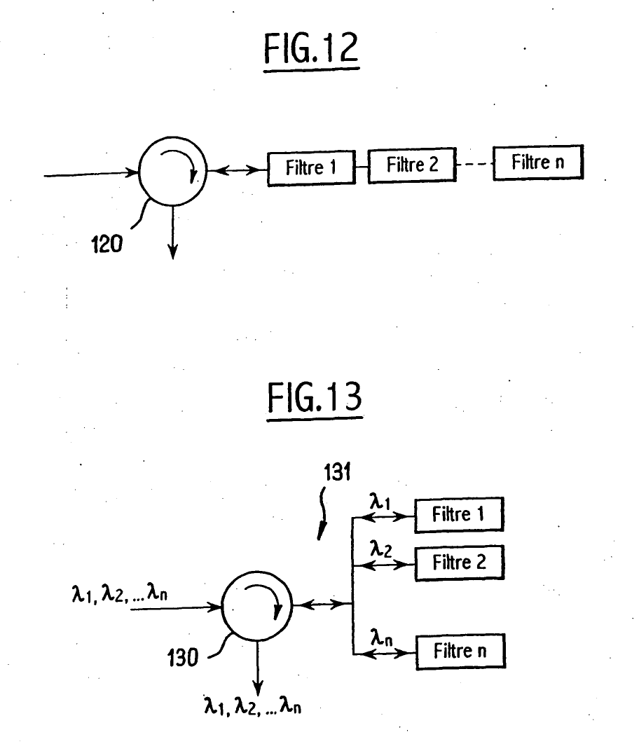

FIG. 12 shows a third embodiment of a system configuration incorporating the invention by the disposition in series of filters associated with different reflective bands; and

FIG. 13 shows a fourth embodiment of a system configuration incorporating the invention and combining a three-port circulator and a plurality of filters using an interleaved multiplexer-demultiplexer.

### DETAILED DESCRIPTION OF THE INVENTION

As indicated hereinabove, the method conforming to the present invention essentially consists in applying to an optical waveguide 10 an operation of controlling the varying interior profile of the waveguide and writing a Bragg grating using techniques enabling independent control of the longitudinal variation of the Bragg wavelength and the longitudinal variation of the exterior profile of the waveguide 10.

The remainder of the description relates to implementations of the present invention in which the step of controlling the varying interior profile of the waveguide is effected by melt-drawing.

In a manner that is known in the art, the optical waveguide 10 on which the invention is based comprises a core 12 surrounded by cladding 14.

To be more precise, the invention is preferably based on an optical waveguide 10 that is invariant on translation. The basic waveguide 10 is characterized by the optogeometrical properties of its cross-section: it may be a “standard” optical fiber, a photonic crystal fiber, a plane waveguide, etc.

It is assumed that, at the operating wavelength, transverse variation of the refractive index enables propagation of light in the longitudinal direction in a particular transverse mode. The waveguide 10 is generally designed so that there is only one such mode. The fundamental mode has an effective index n_{eff} at the operating wavelength.

In the structure of the waveguide, the boundary with the external medium determines the limits of the cross section of the waveguide. Throughout the remainder of the description, the contour of this cross section is referred to as the “exterior profile” of the waveguide.

The invention is based on the following observations stemming from research carried out by the inventors.

The written Bragg grating 20 couples the fundamental mode to the contrapropagating fundamental mode, thereby producing a reflective Bragg filter.

The local resonance wavelength λ_{B}(z), usually referred to as the Bragg wavelength, is given by the following equation, in which n_{eff}(z) is the effective index of the fundamental mode at the longitudinal position z and Λ(z) is the period of the grating at the same longitudinal position z:
π_{B}(z)=2n_{eff}(z)Λ(z) (1)

The coefficient of the coupling between the two modes is proportional to the amplitude of the index modulation and to the overlap integral between the coupled modes and the transverse profile of the index grating.

The spectral response of the filter is completely determined by the longitudinal variation of the Bragg wavelength and the longitudinal variation of the coupling coefficient.

The invention proposes means for combining the control of the method of writing the grating which enables control of the longitudinal variation of the period and of the modulation amplitude combined with control of the variation of the effective index by melt-drawing to obtain the required spectral response. In particular, controlling the longitudinal variation of the modulation amplitude apodizes the spectral response of the filter and/or produces multichannel grating type superstructures.

To make the filter tunable, the inventors propose to vary the applied mechanical traction relative to its value when writing the grating 20.

This may be achieved by various means: stepper motor, piezoelectric element, etc.

Modifying the applied traction modifies the spectral response of the filter by operating on the longitudinal variation of the Bragg wavelength of the grating. As a result of applying traction, two physical effects contribute to the variation of the Bragg wavelength: physical elongation of the material modifies the period and the photo-elastic effect modifies the effective index. These two effects are proportional to the local stress, with the result that the Bragg wavelength variation as a function of the traction is inversely proportional to the area of the local cross section of the waveguide.

To be more precise, considering the waveguide to be of essentially homogeneous composition, the inventors have determined that the following equation applies:

$$\frac{ⅆ {λ}_{B} ( z )}{ⅆ F} = \frac{( 1 - {p}_{e} ) {λ}_{B} ( z )}{E S ( z )} \qquad ( 2 )$$

in which:
F is the applied traction,
pₑ is the photo-elastic coefficient of the material constituting the guide,
E is the Young's modulus of the material, and
S(z) is the area of the cross section of the waveguide at the longitudinal position z.

The preferred application of the invention is to producing a tunable chromatic dispersion compensator.

The spectral response required in this case is characterized by a constant dispersion over the whole of the reflective band whose value is tunable. The inventors have shown that this is equivalent to a first approximation to a linear longitudinal variation of the Bragg wavelength under certain conditions (dispersion below a maximum value depending on the length of the component).

Thus the inventors have shown that, to produce a tunable dispersion compensator, it is desirable for the longitudinal variation of the Bragg wavelength to be linear whatever the applied traction.

Now, this variation is the sum of two contributions that are therefore preferably linear, namely the original variation under the traction conditions for writing the grating and the variation induced when the traction is varied.

Equation (2) shows that this second contribution is linear if the variation of the cross section of the waveguide as a function of z is of the following form, where Sₒ and p are two constants:

$$S ( z ) = \frac{{S}_{o}}{1 + p \cdot z}$$

In the case of a standard optical fiber of circular cross section, this implies the following longitudinal variation of the fiber radius:

$$r ( z ) = \frac{{r}_{o}}{\sqrt{1 + p \cdot z}}$$

(modified exterior profile)

As indicated hereinabove, FIG. 1 shows diagrammatically the steps of a first implementation of a method of the present invention.

FIG. 1a shows in dashed outline the constant cross section exterior profile 11 of the original optical waveguide on which the invention is based. The same FIG. 1a shows the exterior profile 15 of the waveguide 10 obtained after a melt-drawing step and the geometrically similar variation of the interior profile 13 of the core 12.

The melt-drawing step varies the structure of the waveguide 10 longitudinally and in a geometrically similar manner. In the current state of the art it is possible to produce the required profile with longitudinal variation of the cross section of the waveguide; one advantageous method for this is described in patent EP 0 714 861 “Procéde dé fabrication de fibers étirées selon un profil determine” [“Method of fabricating drawn fibers with a particular profile”]. Thus melt-drawing causes controlled longitudinal variation of the area of the cross section of the waveguide.

Moreover, as the guidance effect depends on the transverse dimensions of the waveguide, the melt-drawing process also causes longitudinal variation of the effective index. Knowing the variation of the effective index as a function of the cross section of the waveguide, preferably obtained by experiment, an optical waveguide is produced having the required linear or non-linear longitudinal effective index variation. The longitudinal variation of the profile of the waveguide preferably complies with the adiabatic criterion to ensure that there are no losses caused by coupling from the fundamental mode to higher order modes.

As may seen in FIG. 1a, and as depicted in FIGS. 4a and 4b, in the first implementation of the present invention, the melt-drawing step is controlled to define, at the end of this step, an exterior profile 15 whose variation (see FIG. 4a) is modified to obtain a linear variation of the effective optical index as a function of longitudinal position (FIG. 4b).

This implementation of the method of the invention then includes a step of writing a Bragg grating 20 into the drawn waveguide (see FIG. 1b). One prior art solution for producing the Bragg grating 20 consists in doping the waveguide 10 with a photosensitive material and then irradiating it, for example with a field of ultraviolet fringes created by an interferometer, or alternatively via an appropriate phase mask.

The period of the index grating 20 may be varied a priori. In the context of the first implementation, for which the effective index as a function of longitudinal position varies linearly after the melt-drawing step, the period of the index grating 20 may be constant or vary linearly, as shown in FIG. 4b.

As shown in FIG. 1c, to control the longitudinal variation of the cross section of the waveguide and thereby to control the variation of the spectral response as a function of the traction force, the melt-drawing step shown in FIG. 1a is followed by local correction of the exterior profile 15 of the drawn waveguide. This correction step is applied without modifying the longitudinal variation of the index profile. Thus FIG. 1c shows a correction step that consists in correcting the exterior profile 15 of the waveguide by reducing it. This kind of correction may be applied by gradual chemical attack along the waveguide. One non-limiting example of this kind of correction step is effected by etching by immersion in a bath of hydrofluoric acid.

Alternatively, as shown diagrammatically in FIG. 2, the step of correcting the exterior profile may be effected by adding a material with mechanical properties analogous to those of the material constituting the waveguide. FIG. 2 shows the exterior profile 16 of the waveguide after adding the required material.

FIG. 1c shows the exterior profile 16 of the waveguide after carrying out the correction step. FIG. 4c shows the radius of the waveguide as a function of longitudinal position obtained after the correction step. Similarly, FIG. 4d shows the period of the index grating 20 varying linearly as a function of longitudinal position. The combination of linear variation of the effective index shown in FIG. 4b and linear variation of the period of the index grating shown in FIG. 4d produces a linear variation of the Bragg wavelength in the manner shown in FIG. 4e.

A second implementation of the present invention is described next with reference to FIGS. 3 and 5.

Unlike the first implementation, described hereinabove with reference to FIGS. 1 and 2, which consists in carrying out the melt-drawing operation to obtain a preferred variation of the effective index, in the second implementation, as shown in FIGS. 3 and 5a, the melt-drawing operation is carried out to obtain the required longitudinal variation of the cross section of the waveguide. This variation is again determined in order to control the spectral variation as a function of traction.

Accordingly, as shown in FIG. 5b, a non-linear longitudinal variation of the effective index is obtained after this melt-drawing step.

In this context, as may be seen in FIG. 3 and in FIG. 5c, the Bragg grating 20 is written with a non-linear variation of its period so that the combination of the non-linear variation of the effective index (FIG. 5b) and the non-linear variation of the index grating period (FIG. 5c) again produces a linear variation of the Bragg wavelength as a function of longitudinal position (FIG. 5d).

FIG. 3 also shows a preferred metallic deposit 18 produced on the exterior surface of the waveguide to enable adjustment of the value of the central wavelength of the filter by controlling the temperature.

The invention teaches the application of a uniform temperature rise to adjust the value of the central wavelength of the filter. This wavelength adjustment is necessary in particular when tuning the spectral response of the component in the manner indicated above, because the traction induces a variation in the central wavelength of the filter. This adjustment may also be necessary to obtain an athermal component, i.e. a component whose optical performance is maintained, in the specified range of use of the component, regardless of the external temperature.

To this end, the invention proposes to form on the surface 15 of the drawn waveguide 10 a metallic deposit 18 with its thickness modified as a function of the size of the cross section.

This deposit may consist of stacked metallic layers of different kinds.

If an electrical current flows in the metallization, electrical power is converted into heat by the Joule effect, helping to heat the waveguide.

It may be shown that, to achieve a uniform temperature rise, the longitudinal variation of the thickness of the metallic deposit must be inversely proportional to that of the area of the waveguide.

FIG. 8b shows that, for a linear variation of the radius of the drawn waveguide as a function of longitudinal position, the temperature rise (curve e1 in FIG. 8b) is non-linear for a uniform deposit thickness (curve e2 in FIG. 8b). On the other hand, FIG. 8c shows that for a non-linear variation of the deposit thickness (curve e3 in FIG. 8c), a linear temperature variation as a function of the longitudinal position is obtained (curve e4 in FIG. 8c).

Thus FIG. 8 shows the need to modify the thickness of the metallization to obtain a uniform temperature rise in the case of a guide in which the size of the cross section varies longitudinally. In this example, the waveguide is a linear taper: for the same input electrical power (P=126 milliwatts (mW) for a metallized length of 4 centimeters (cm)), the temperature varies along the guide from 50° C. to more than 100° C. if the deposited thickness is uniform, whereas it is constant and equal to 75° C. in the case of a modified thickness.

Alternatively, the metallization may be heated by thermal conduction.

In a variant applicable to the situation in which the waveguide 10 is an optical fiber, the uniform temperature rise may be obtained by inserting the fiber 10 into a tube 30 that is heated, acting as a microfurnace. FIG. 9 shows a variant of this kind. The tube 30, whose inside diameter is slightly greater than the maximum diameter of the fiber, may either be a metallized silica capillary, in which case the deposit is of uniform thickness, or consist directly of a conductive material such as graphite.

FIG. 9 shows diagrammatically an electrical power supply 32 adapted to supply a controlled electrical current to the terminals of a capillary 30.

Once again, the capillary or microfurnace may be heated by thermal conduction instead of by the Joule effect.

Throughout the foregoing description it has been implicitly assumed that the waveguide 10 is not birefringent. If this is not the case, there is a spectral offset between the reflection responses corresponding to the two principal states of polarization. In particular, this induces a phenomenon known as polarization mode dispersion (PMD) which degrades optical transmission quality. It is therefore generally desirable to minimize the birefringence of the optical waveguide, whether it is inherent or induced by the component fabrication process (melt-drawing, writing the Bragg grating). Nevertheless, a birefringent waveguide, of the polarization maintaining fiber type, may be envisaged if the component is to be used as a PMD compensator. To this end the waveguide typically has a birefringence Δn≧10⁻⁵.

The invention may be based on any appropriate optical waveguide adapted to withstand a melt-drawing operation and to receive a Bragg grating.

It is preferably based on an optical fiber.

Consider an optical fiber in which three regions may be distinguished: doped core, doped inner cladding, and silica outer cladding.

For producing the Bragg grating on the drawn fiber, the invention proposes using a fiber with stretched photosensitive cladding. It is known in the art, in particular from the document “Optical fiber design for strong gratings photoimprinting [sic] with radiation mode suppression”, Proc. OFC'95 26 Feb.-3 Mar. 1995 pp. 343-345, that losses from coupling to the cladding modes may be eliminated by introducing, by means of appropriate doping, optical cladding whose photosensitivity is equal to that of the core.

Because the ratio between the size of the guided mode and the radius of the core increases as the latter decreases, it would seem desirable for the ratio between the radius r_{g} of the photosensitive cladding and the radius r_{c} of the core to be sufficiently large to eliminate coupling between the cladding modes equally effectively over the whole length of the drawn fiber, in particular at small diameters.

Typically, r_{g}≧3.rₒ achieves this result for a variation of the fiber diameter from 125 μm to 90 μm.

The invention teaches using a stretched silica cladding fiber to increase the mechanical strength of the drawn fiber. The maximum traction before rupture being proportional to the cross section, it is desirable to increase the radius of the silica cladding but to retain the same index profile to reduce the risk of breaking at the location of the smaller fiber cross section resulting from melt-drawing.

Tests carried out by the inventors have shown that the present invention offers many advantages over the prior art thanks to independent control of the interior and exterior profiles of the fiber cladding.

With particular reference to controlling the exterior profile, the various solutions proposed in the past have not used a melt-drawing operation; starting from a standard fiber, they consisted either in applying a deposit of variable thickness or in executing a gradual chemical attack. The drawbacks of these solutions are that the technology for producing gradual thickness variations is not simple and the maximum thickness variation is large and therefore a priori more difficult to control. Moreover, as indicated above, the melt-drawing process provides simple and accurate control of the longitudinal variation of the shape of the waveguide.

FIG. 6 shows the benefit of a modified exterior profile, still in the context of a tunable chromatic dispersion compensator. As may be seen in FIG. 6b, if the exterior profile is not modified, for example by linear variation of the radius, the tuning range is limited by higher order dispersion; the dispersion is no longer constant in the wanted signal band, which induces distortion that degrades transmission quality. In the contrary situation of the invention, an extended tuning range is obtained, as may be seen in FIG. 6c. In particular, it is possible to invert the sign of the dispersion compensation.

Specific applications may be envisaged for positive and negative dispersion compensation.

FIG. 7 shows additional possibilities offered by controlling the longitudinal variation of the index modulation when writing the Bragg grating.

Firstly, apodization of the spectral response and reduction of the amplitude of the undulations in the delay curve may be obtained by progressively reducing the modulation amplitude at the edges of the grating.

Secondly, a plurality of reflective bands may be created by overmodulating the index modulation.

The dispersion compensator of the present invention can simultaneously process a plurality of channels with different wavelengths and thus minimize the number of compensators that have to be used.

FIG. 7 shows another application of the invention in the case of a tunable dispersion compensator; a Bragg grating has been written for generating two reflective bands whose spectral spacing corresponds to the offset produced by the additional traction force needed to invert the dispersion sign, in which case a different reflective band is used according to the sign of the dispersion to be compensated.

To be more specific, FIG. 7 shows a reflectivity curve r₁ obtained with the original traction force for writing the Bragg grating and a delay curve r₂ obtained at that original traction force. It will be noted that the curve r₁ comprises two separate bands r₁₁ and r₁₂, the band r₁₂ being centered on a wavelength λₛ that corresponds to the wavelength of the wanted signal.

FIG. 7 also shows a reflectivity curve r₃ obtained after applying an additional controlled traction force to invert the sign of the dispersion, and a corresponding delay curve r₄. It will be noted that the curve r₃ comprises two separate bands r₃₁ and r₃₂ identical to the bands r₁₁ and r₂₁, respectively. However, here the band r₃₁ is centered on the same wavelength λs as the band r₁₂.

Thus, whilst operating at the wavelength λs, the invention enables a change from the band r₃₁ to the band r₁₂, and vice-versa, according to whether additional traction is applied or not, with the result that the sign of the compensation may be inverted or not.

The present invention may be used in many system configurations.

Some non-limiting examples are described next.

If implemented as a reflection filter, the component F may be associated with a splitter, such as a three-port circulator, or a filter, to extract the output signal. To filter a plurality of channels or sub-bands independently, one solution is to interleave a multiplexer-demultiplexer between the circulator and the components associated with each channel or sub-band.

To provide dynamic tunability, measuring the quality of the transmitted signal combined with measuring the external conditions enables traction and temperature control feedback to be applied in order to maintain optimum filter performance.

It may be beneficial to combine a fixed filter and a tunable filter (or even two tunable filters). For example, a four-port circulator is used in this case, or two three-port circulators in series, which amounts to the same thing.

In all the above configurations, each filter may be replaced by an equivalent series combination of filters corresponding to different reflective bands.

FIG. 10 shows a system that comprises a three-port circulator 100 which receives at its input the signal from a dispersive transmission line 102. Its intermediate port is connected to the input of a tunable filter F of the invention. A feedback loop comprises a measuring device 104 sensitive to the response of the filter F and a module 108 controlled by the device 104 to control the traction force and the temperature of the filter F. This configuration recovers a filtered signal at the output of the three-port circulator 100.

FIG. 11 shows a system that comprises a four-port circulator 110 which receives a signal at its input. Two fixed or tunable filters F1, F2 are connected to respective intermediate ports of the circulator. The filtered signal is recovered at the output of the circulator 110.

The four-port circulator 110 shown in FIG. 11 may be replaced by two three-port circulators in series. In this case, the first three-port circulator receives the signal at its input, its intermediate port is connected to the filter F1, and its output is connected to the input of the second circulator, which has its intermediate port connected to the filter F2. The filtered output signal is available at the output of the second circulator.

FIG. 12 shows a system that comprises a three-port circulator 120 which receives a signal at its input. Filters conforming to the present invention and denoted filter 1, filter 2, . . . , filter n in FIG. 12 are connected in series to the intermediate port of the circulator 120. The filtered signal is recovered at the output of the circulator 120.

FIG. 13 shows a system that comprises a three-port circulator 130 which receives at its input a signal comprising multiple wavelengths λ1 to λn. Its intermediate port is connected to a demultiplexer-multiplexer 131 whose outputs, at which the various wavelengths λ1 to λn are available, are connected to respective filters denoted filter 1, filter 2, . . . , filter n in FIG. 13. The filtered signal comprising multiple wavelengths λ1 to λn is available at the output of the circulator 130.

Of course, the present invention is not limited to the particular implementations that have just been described, and encompasses any variant thereof conforming to the spirit of the invention.

In particular, the present invention is not limited to the specific applications described above.

It applies to all compatible applications and in particular, for example, to the production of a variable reflectivity filter serving as a tunable mirror in a Raman laser.

Moreover, the step of controlling the varying interior profile of the waveguide by melt-drawing may be replaced by any equivalent means, for example by chemical attack combined with diffusion or any equivalent means.

1. A method of producing an optical filter, comprising:
controlling a varying interior profile of an optical waveguide, and
forming a Bragg grating in the interior profile of the optical waveguide,
by allowing independent control of a longitudinal variation of the Bragg wavelength and a longitudinal variation of an exterior profile of the optical waveguide.

2. A method according to claim 1, wherein controlling the varying interior profile of the waveguide is effected by melt-drawing.

3. A method according to claim 1 further comprising a applying a mechanical force to the optical waveguide.

4. A method according to claim 3, further comprising applying a controlled traction to the optical waveguide.

5. A method according to claim 3, further comprising applying a controlled torsion to the optical waveguide.

6. A method according to claims 1, wherein controlling the varying interior profile of the optical waveguide further comprises controlling the longitudinal variation of an effective optical index of the optical waveguide.

7. A method according to claims 1, wherein controlling the varying interior profile of the optical waveguide is effected under conditions allowing control of the longitudinal variation of an effective optical index of the waveguide and further comprising locally correcting the exterior profile of the waveguide and the enabling longitudinal control of the Bragg wavelength.

8. A method according to claim 7, wherein forming the Bragg grating further comprises producing a constant period or linear grating.

9. A method according to claim 7, wherein locally correcting the exterior profile of the waveguide is effected before forming the Bragg grating.

10. A method according to claim 7, wherein locally correcting the exterior profile of the waveguide is effected after forming the Bragg grating.

11. A method according to claim 7, wherein locally correcting the exterior profile of the waveguide further comprises removing material from the exterior profile of the waveguide.

12. A method according to claim 7, wherein correcting the exterior profile comprises adding material to the exterior profile obtained after controlling the varying interior profile of the waveguide.

13. A method according to claim 1, wherein controlling the varying interior profile of the waveguide comprises controlling the exterior profile of the optical waveguide.

14. A method according to claim 13, wherein controlling the varying interior profile of the optical waveguide is effected under conditions enabling control of the longitudinal variation of the exterior profile of the waveguide and the longitudinal variation of the grating is controlled during formation of the Bragg grating to enable control of the longitudinal variation of the Bragg wavelength.

15. A method according to claim 7, wherein forming the Bragg grating comprises adapting the Bragg grating to define a variable period.

16. A method according to claim 1, wherein controlling the varying interior profile of the waveguide and forming the Bragg grating are adapted to define a longitudinal linear variation of the Bragg wavelength.

17. A method according to claim 1, wherein controlling the exterior profile of the waveguide comprises defining a non-linear variation of the exterior profile.

18. A method according to claim 15, wherein controlling the exterior profile of the waveguide comprises defining an exterior profile whose cross section conforms to the following equation, in which Sₒ and p are constants and z defines the longitudinal axis:
$$S ( z ) = \frac{{S}_{o}}{1 + p \cdot z}$$

19. A method according to claim 1, comprising forming a uniform longitudinal variation of the Bragg wavelength along the optical waveguide.

20. A method according to claim 19, further comprising adding means adapted to control the temperature along the longitudinal direction of the optical waveguide.

21. A method according to claim 19, further comprising depositing an electrically or thermally conductive material, on the waveguide.

22. A method according to claim 21, wherein the thickness of the conductive material is non-uniformly deposited along the fiber.

23. A method according to claim 22, wherein the longitudinal variation of a thickness of the deposit is inversely proportional to the cross section of the optical-waveguide.

24. A method according to claim 19, further comprising placing the waveguide in a microfurnace.

25. A method according to claim 1, wherein the Bragg grating is formed after varying interior profile of the optical-waveguide.

26. A method according to any one of claims 1, wherein the optical waveguide is an optical fiber.

27. A method according to any one of claim 1, wherein the optical waveguide is an optical fiber that includes a doped core, a doped inner cladding, and silica outer cladding.

28. (canceled)

29. A method according to claim 1, wherein forming the Bragg grating includes controlling the modulation amplitude of an index of the optical waveguide.

30. A method according to claim 29, the modulation amplitude is progressively reduced at the edges of the grating to apodize the spectral response.

31. A method according to claim 29, wherein an index modulation is overmodulated to create a plurality of reflective bands.

32. A method according to claims 1, wherein the Bragg grating is formed generating two reflective bands whose spectral spacing corresponds to an offset produced by a force necessary for inverting the sign of the dispersion.

33. A filter, comprising:
an optical waveguide having an exterior profile extending in a longitudinal direction and an interior profile extending in the longitudinal direction; and
a Bragg grating formed along the interior of the optical waveguide by varying the interior profile of the optical waveguide, independently controlling a variation of a Bragg wavelength along the longitudinal direction and independently controlling a variation of the exterior profile of the optical waveguide along the longitudinal direction.

34. (canceled)

35. A filter according to claim 33, wherein the optical waveguide is made in whole or in part by a melt-drawing process.

36. A filter according to claim 33, wherein the Bragg grating comprises a reflective component.

37. A filter according to claim 33, wherein the exterior profile is obtained by modifying the profile obtained after varying the interior profile of the optical waveguide.

38. A filter according to claim 33, wherein exterior profile is obtained by controlling the variation of the interior profile of the waveguide.

39. A filter according to claim 37, wherein the Bragg grating has a constant or linear period.

40. A filter according to claim 37, wherein the Bragg grating has a varying period.

41. A filter according to claims 33, wherein the longitudinal variation of the Bragg wavelength is linear.

42. A filter according to claim 33, wherein the Bragg grating comprises temperature control means.

43. A filter according to claim 33, further comprising an electrically or thermally conductive material deposited in the Fiber Bragg grating.

44. A filter according to claim 33, wherein the filter is formed in a microfurnace.

45. A filter according to claim 33, wherein the optical waveguide is made from birefringent material.

46. A filter according to claim 45, wherein the waveguide has a birefringence Δn≧10⁻⁵.

47. A filter according to claim 33, wherein the optical waveguide includes a core and an inner cladding and the photosensitivities of the core and the inner cladding of the waveguide are similar and the radius of the inner cladding is more than three times that of the core.

48. A filter according to claims 33, wherein the waveguide comprises a stretched silica cladding fiber.

49. A filter according to claim 33, further comprising applying a force application means based on one or more piezo-electric cells to form the Bragg grating.

50. A filter according to claim 33, wherein the force is applied by one or more step-up motors.

51. A filter according to claims 49, measuring the optical properties of the waveguide or the transmission quality of the waveguide and using the measured optical properties or transmission quality to provide feedback to control the applied force.

52. A system comprising:
an optical waveguide having an exterior profile extending in a longitudinal direction and an interior profile extending the longitudinal direction;
a Bragg grating formed along the interior of the optical waveguide by varying the interior profile of the optical waveguide, independently controlling a variation of a Bragg wavelength along the longitudinal direction and independently controlling a variation of the exterior profile of the optical waveguide along the longitudinal direction; and
means for applying a controlled mechanical force to the filter.

52. A system according to claim 52, wherein the filter comprises a splitter such as a three-port circulator associated with a filter for extracting an output signal.

54. A system according to claim 52, further comprising a multiplexer-demultiplexer associated with a plurality of the filters, each filter being operative to independently filter a plurality of channels or sub-bands.

55. A system according to claim 52, wherein the filter comprises at least two filters of which at least one is preferably tunable.

56. A system according to claim 55, further comprising a four-port circulator with two intermediate ports respectively connected to the at least two filters.

57. A system according to claim 55, further comprising two three-port circulators each having intermediate ports respectively connected to the at least two filters, an output port and an input port, the output port of the first circulator being connected to the input of the second.

58. A system according to claim 52, further comprising a plurality of filters in series.

59. A system according to claim 52, further comprising means for measuring optical properties or a transmission quality of the filter and for applying feedback to control formation of the filter based on the optical properties on the transmission quality.
